(19) United States
(12) Patent Application Publication
(10) Pub. No.: US 2014/0195944 A1
(43) Pub. Date: Jul. 10, 2014

(54) MANAGEMENT OF RESOURCES FOR TASKS WITH VIRTUAL COMPOSITE SERVICE AGENTS

(71) Applicant: INTERNATIONAL BUSINESS MACHINES CORPORATION, Armonk, NY (US)

(72) Inventors: Lorraine M. Herger, Port Chester, NY (US); Neal M. Keller, Pleasantville, NY (US); Matthew A. McCarthy, Holly Springs, NC (US); Clifford A. Pickover, Yorktown Heights, NY (US)

(73) Assignee: INTERNATIONAL BUSINESS MACHINES CORPORATION, Armonk, NY (US)

(21) Appl. No.: 13/737,878

(22) Filed: Jan. 9, 2013

(51) Int. Cl. G06F 3/0486

(52) U.S. Cl. CPC G06F 3/0486
USPC 715/769

(57) ABSTRACT

A system, method and computer product for managing resources for tasks. An example system includes a rules database storing requirements and restrictions associated with a task. A graphical user interface contains resource icons of resources that can, at least partially, fulfill the requirements of the task and a virtual service agent (VSA) icon of a VSA associated with the task. When a resource icon is attempted to be dragged and dropped onto the VSA icon, the graphical user interface permits or prohibits the dragging and dropping responsive to a rules-checking module that checks violations of the restrictions. Furthermore, an agent-checking module ensures that at least one resource includes a software agent configured to answer natural language questions. The software agent queries data repositories and applies language processing, information retrieval, and machine learning to arrive at a conclusion.

### BACKGROUND

This invention relates to managing resources for tasks, and more particularly to a system for fulfilling task requirements using one or more virtual service agents (VSAs).

Increasingly global interactions among cultures, people, businesses, and business units have led to various challenges involving traditional work management, which must rapidly evolve and adjust to oversee highly efficient virtual teams composed of individuals in different municipalities, states, and nations. This large sprawl of resources, skills, and constraints must typically take into account various laws, regulations, risks, and social networks, along with the rise of artificial intelligence agents that may contribute to a team's efficient and accurate functioning. Conventional task management systems often fail to addresses these challenges.

### BRIEF SUMMARY

Accordingly, one example aspect of the present invention is a system for managing resources for tasks. The system includes a rules database storing requirements and restrictions associated with a task. The system also includes a graphical user interface including resource icons of resources that can, at least partially, fulfill the requirements of the task and a virtual service agent (VSA) icon of a VSA associated with the task. When a resource icon is attempted to be dragged and dropped onto the VSA icon, the graphical user interface permits or prohibits the dragging and dropping responsive to a rules-checking module that checks violations of the restrictions. Furthermore, the system includes an agent-checking module that ensures that at least one resource includes a software agent configured to answer natural language questions by querying data repositories and applying elements of language processing, information retrieval, and machine learning to arrive at a conclusion.

Another example aspect of the present invention is a method for managing resources for tasks. The method includes storing requirements and restrictions associated with a task in a rules database. The method further includes displaying a graphical user interface including resource icons of resources that can, at least partially, fulfill the requirements of the task and a virtual service agent (VSA) icon of a VSA associated with the task. When a resource icon is attempted to be dragged and dropped onto the VSA icon, the graphical user interface permits and prohibits the dragging and dropping in response to a rules-checking module that checks violations of the restrictions and a checking module. The checking module ensures that at least one resource includes a software agent configured to answer natural language questions by querying data repositories and applying elements of language processing, information retrieval, and machine learning to determine answers to the natural language questions.

Yet another example of the present invention is a computer program product for managing resources for tasks. The computer program product includes computer readable program code configured to store requirements and restrictions associated with a task in a rules database, and display a graphical user interface including resource icons of resources that can, at least partially, fulfill the requirements of the task, and a virtual service agent (VSA) icon of a VSA associated with the task such that when a resource icon is attempted to be dragged and dropped onto the VSA icon, the graphical user interface permits and prohibits the dragging and dropping responsive to a rules-checking module that checks violations of the restrictions and a checking module that ensures that at least one resource includes a software agent configured to answer natural language questions by querying data repositories, and applying language processing, information retrieval and machine learning to determine answers to the natural language questions.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a system for managing resources for tasks according to one embodiment of the present invention. FIG. 1 also shows an example embodiment of using a graphical user interface on which human resources and AI DeepQA resources are shown.

FIG. 2 shows a VSA formation component (VFC) that forms the VSA.

FIG. 3 shows a method for managing resources for tasks using social-network connectivity characteristics in accordance with one embodiment of the present invention.

FIGS. 4A and 4B show another method for managing resources for tasks in accordance with one embodiment of the present invention.

### DETAILED DESCRIPTION

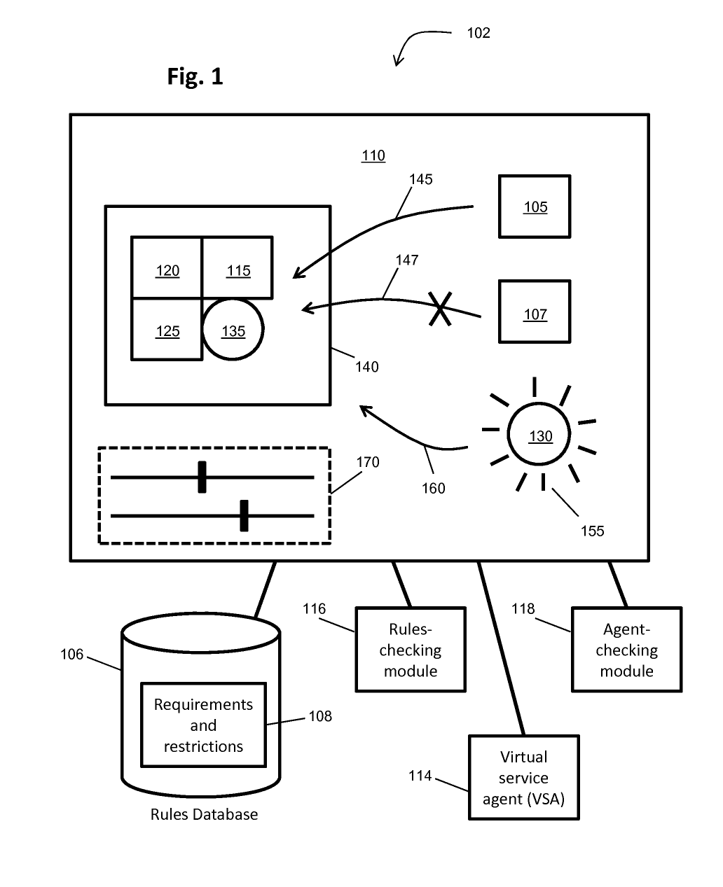

The present invention is described with reference to embodiments of the invention. Throughout the description of the invention reference is made to FIGS. 1-4B. When referring to the figures, like structures and elements shown throughout are indicated with like reference numerals.

FIG. 1 shows a system 102 for managing resources for tasks according to one embodiment of the present invention. As used herein, a task is an undertaking to be completed and a resource is something or someone that assists in completing the undertaking. The system 102 includes a rules database 106. The rules database 106 stores requirements and restrictions 108 associated with a task.

The system 102 further includes a graphical user interface 110. The graphical user interface 110 includes resource icons 105, 107, 115, 120, 125, 130, 135 of resources. The resources can, at least partially, fulfill the requirements 108 of the task. The graphical user interface 110 also includes a virtual service agent (VSA) icon 140 of a VSA 114 associated with the task. The VSA 114 is an assembly of resources responsible for completing the task requirements within the specified restrictions.

When a resource icon is attempted to be dragged and dropped onto the VSA icon 140, the graphical user interface 110 may permit 145 or prohibit 147 the dragging and dropping responsive to a rules-checking module 116. The rules-checking module 116 checks violations of the requirements and restrictions 108. The system 102 includes an agent-checking module 118. The agent-checking module 118 ensures that at least one resource in the VSA 114 (represented by the VSA icon 140) is a software agent 130, 135.

In one embodiment, the software agent 130, 135 is an artificial intelligent agent resource, also referred to herein in as an artificial intelligence (AI) DeepQA resource, also referred to as Deep Question-Answering. An AI DeepQA resource is a computer system that answers natural language questions by querying data repositories and applying elements of language processing, information retrieval, and machine learning to arrive at a probabilistic answer. More information about the AI DeepQA resource contemplated by the present invention can be found in U.S. patent application Ser. No. 12/152,411 titled “System and method for providing answers to questions”, filed May 14, 2008, and incorporated wherein in its entirety.

FIG. 1 shows an example embodiment of using the graphical user interface 110 displaying human resource icons 105, 107, 115, 120, 125 and software agents 130, 135. A virtual composite service agent icon 140 is shown composed of three human resource icons 115, 120 and 125, and one software agent 135. In some embodiments, the software agent may represent computing systems.

When composing a VSA 114, a user may drag 145 resources to the VSA icon 140 in an attempt to construct teams, or composite entities, with appropriate characteristics and to comply with known restrictions 108 (e.g., including legal and regulatory restrictions and various social network characteristics). Thus, the VSA icon 140 is a visual representation of the assembled team.

During the dragging of a resource icon, a user may sometimes be prohibited 147 from adding the resource represented by the icon to the VSA icon 140. For example, if the VSA 114 is desired to be composed of four resources, one of which is required to be an AI DeepQA resource, dragging four non-AI DeepQA resources to the VSA icon 140 may be prohibited, so as to ensure one of the four resources is an AI DeepQA resource. Similarly, a resource may be prohibited 147 from adding to a VSA 114 for reasons concerning legal, regulatory, or social network characteristics. For example, it may be desirable to have a least one resource member of a VSA 114 be socially well-connected to other resources in a social network. If a resource does not have sufficient connectivity, the resource may be denied access to the VSA formation process. Social network connectivity may be estimated by many methodologies, including an analysis of email recipients and senders, instant message transmissions, phone calls, tweets in Twitter, etc. For example, if one resource is in frequent contact with ten other experts, he or she is considered have a greater connectivity than a resource that is never in contact with other experts.

To preserve privacy, such a social network analysis may be done in an opt-in basis, when a user permits such an analysis. Also, to preserve privacy, the analysis may store only an indication of the amount or nature of the connectivity, but not the names of the various contacts. Social network connectivity may also take into consideration connections between a person and an AI DeepQA agent. For example, if a user makes frequent use of more than one AI DeepQA agent in obtaining help in answering questions, this person may be considered to have a higher connectivity than a person who never uses an AI DeepQA agent.

Additionally, the use of certain resources 105, 107, 130 may be encouraged for addition to the VSA 114. For example, if the VSA 114 is desired to be composed of four resources, one of which is required to be an AI DeepQA resource, the encouragement may take the form of the AI DeepQA resource changing graphical attributes (e.g., blinking) 155 or moving 160 of the resource icon toward the VSA icon 140. In this manner, the user may more easily, and intuitively, form the VSA 114 with useful characteristics. The means for moving icons on a screen is known to those skilled in the art of computer graphics and GUIs. Similarly, changing graphical characteristics (size, color, brightness, blink rate, texture, shading, fonts, etc.) is known to those in the art. In a virtual world representation, such graphical characteristics may also include avatar appearance, avatar clothing, etc.

Similarly, a repulsion of resources from the VSA icon 140 may take place when the resource is not appropriate for use in a VSA 114. This repulsion may take the form of a change in graphical characteristics or an actual repulsive movement away from the VSA icon 140.

The graphical user interface 110 can include at least one visual widget 170 to adjust at least one of the requirements and the restrictions 108 of the task. Furthermore, the VSA icon 140 can show the amount of unfulfilled requirements 108 of the task.

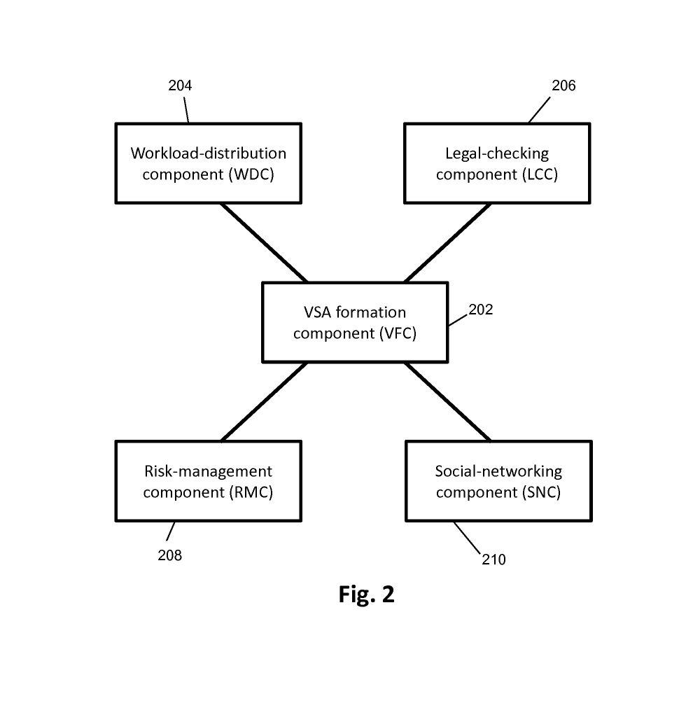

FIG. 2 shows a VSA formation component (VFC) 202 that forms the VSA 114. The VFC 202 adjusts properties of the VSA 114 based on signals from a workload-distribution component (WDC) 204, a legal-checking component (LCC) 206, a risk-management component (RMC) 208, and/or a social-networking component (SNC) 210. The WDC 204, LCC 206, RMC 208, and SNC 210 may make use of the requirements and restrictions 108.

In one embodiment, the graphical user interface may prohibit dragging and dropping a selected resource icon to the VSA icon if the WDC 204, LCC 206, RMC 208 and/or SNC 210 indicates that the selected resource does not meet the requirements and restrictions of the task. The graphical user interface may encourage dragging and dropping the selected resource icon onto the VSA if the WDC 204, LCC 206, RMC 208 and SNC 210 indicate that the selected resource meets the requirements and restrictions 108 of the task. If the WDC 204, LCC 206, RMC 208 and SNC 210 indicate that the selected resource meets the requirements and restrictions of the task, this may be visually represented by the resource icon starting to move toward the VSA icon or becoming brighter, for example. Furthermore, dragging and dropping a resource icon onto the VSA icon may automatically trigger a query for a resource that can, at least partially, fulfill remaining requirements of the task.

The WDC 204, LCC 206, RMC 208 and SNC 210 make use of rules stored in a database. The VSA may be represented by a VSA icon in a drag-and-drop interface. The VSA icon drag-and-drop interface may be used to make assignments of service agents (e.g., help-desk agents), and drop regions may represent any of: tasks, data centers, geographies, help desks, etc. Additionally, a social-network component (SNC) 210 may be used to estimate various attributes (e.g., social connectivity) of people that form the VSA.

The appearance of the VSA icon may represent any of countries of the people, expertise, legal concerns, workload concerns, risk concerns, cost concerns, social-network attributions, the presence of a DeepQA software agent as part of the team, etc. DeepQA systems are those systems that answer natural language questions by querying data repositories and applying elements of language processing, information retrieval, and machine learning to arrive at a conclusion.

As discussed above, the VSA may also include software agents (in the mix with actual people). Such agents can address certain legal concerns or reduce risks in certain contexts. Machine learning can be used to discover new contexts (risk scenarios). When the VSA is employed as a composite caregiver, health service agent, or legal assistant, the risk-management component (RMC) 208 may be used to guarantee that at least one member of the VSA 114 is an artificial intelligence (AI) computer system capable of answering questions posed in natural language, using DeepQA technology, to reduce medical errors, enhance medical diagnosis, or increase the chances of legal correctness with the help of the AI's advanced analytics technology. A VSA with a software agent resource may be used in such diverse applications as help-desks and personal services, such as home health care aide, psychotherapist, financial advisor, etc.

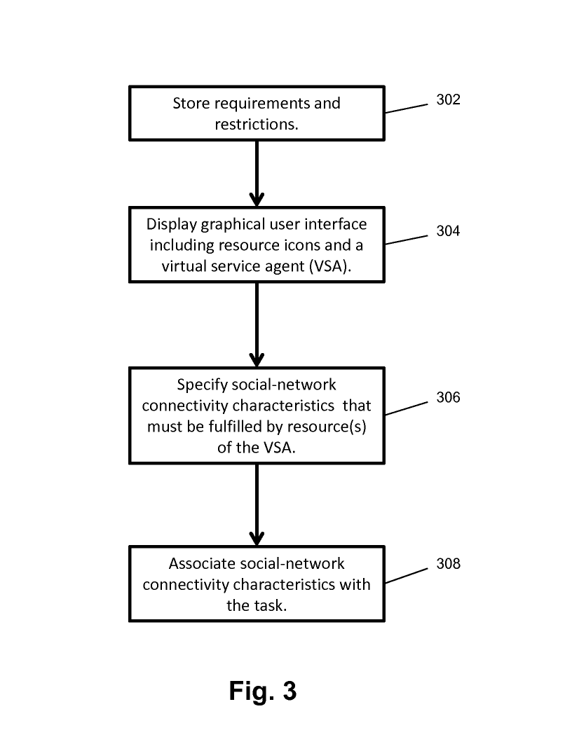

FIG. 3 shows a method for managing resources for tasks using social-network connectivity characteristics in accordance with one embodiment of the present invention. The method includes a storing step 302. During storing step 302, requirements and restrictions associated with a task are stored in a rules database. After storing step 302 is completed, the process continues to displaying step 304.

At displaying step 304, the graphical user interface displays resource icons of resources. The resources can, at least partially, fulfill the requirements of the task and a virtual service agent (VSA) icon of a VSA associated with the task. When a resource icon is attempted to be dragged and dropped onto the VSA icon, the graphical user interface may permit and prohibit the dragging and dropping responsive to a rules-checking module that checks violations of the restrictions. The graphical user interface may also permit and prohibit the dragging and dropping responsive to an agent-checking module. The agent-checking module may ensure that at least one resource includes a software agent configured to answer natural language questions by querying data repositories. The software agent may apply elements of language processing, information retrieval, and machine learning to determine answers to the natural language questions.

In one embodiment, the graphical user interface includes graphical widgets to adjust the requirements and restrictions associated with the task. In response to adjustments to the requirements and restrictions associated with the task, the graphical user interface may change an appearance of the VSA icon to indicate a remaining amount of unfulfilled requirements associated with the task. After displaying step 304 is completed, the process continues to specifying step 306.

At specifying step 306, social-network connectivity characteristics that must be fulfilled by one or more resources of the VSA are specified in the rules database. Once specifying step 306 is completed, the process continues to associating step 308.

At associating step 308, social-network connectivity characteristics are associated with the task. In one embodiment, the social-network connectivity characteristics may include a degree centrality parameter specifying a minimum number of direct relationships of the VSA, a betweenness centrality parameter specifying the VSA's minimum position within a network in terms of its ability to make connections to other entities in a network, a closeness parameter specifying how quickly the VSA can access more entities in the network, an Eingenvalue parameter specifying how close the VSA is to other highly close entities within the network, an authority parameter specifying the minimum number of network nodes that point to the VSA, and a hub parameter specifying the minimum number of authorities the VSA must point to.

Degree centrality is the number of direct relationships that an entity has. An entity with high degree centrality: (1) is an active player in the network, (2) may be a connector or hub in the network, (3) may not be the most connected entity in the network (an entity may have a large number of relationships, the majority of which point to low-level entities), (4) may be in an advantaged position in the network, (5) may have alternative avenues to achieve organizational needs, and may be less dependent on other individuals, and (6) can typically be identified as third parties or deal makers.

Betweenness centrality identifies an entity's position within a network in terms of its ability to make connections to other pairs or groups in a network. An entity with a high betweenness centrality: (1) may hold a favored or powerful spot in the network, (2) may represent a single point of failure (that is, if the single betweenness spanner is taken out of a network ties between cliques are severed), and (3) may have a higher amount of influence over network activity.

Closeness centrality is a measure of how fast an entity can access more entities in a network. An entity with a high closeness centrality: (1) may have quick access to other entities in a network, (2) may have a short path to other entities, (3) may be in proximity to other entities, and (4) may have high visibility as to what is happening in the network.

Eigenvalue measures how close an entity is to other close entities in the network. Eigenvalue identifies the most central entities in terms of the global or overall makeup of the network. A high Eigenvalue: (1) may indicate a network node that is more central to the main pattern of distances among all entities, and (2) may be a reasonable measure of one aspect of centrality in terms of positional advantage.

Authorities are entities that many other entities point to. If an entity has a high number of relationships pointing to it, it has a high authority value, and (1) may be a knowledge or organizational authority within a domain, and (2) may act as definitive source of information.

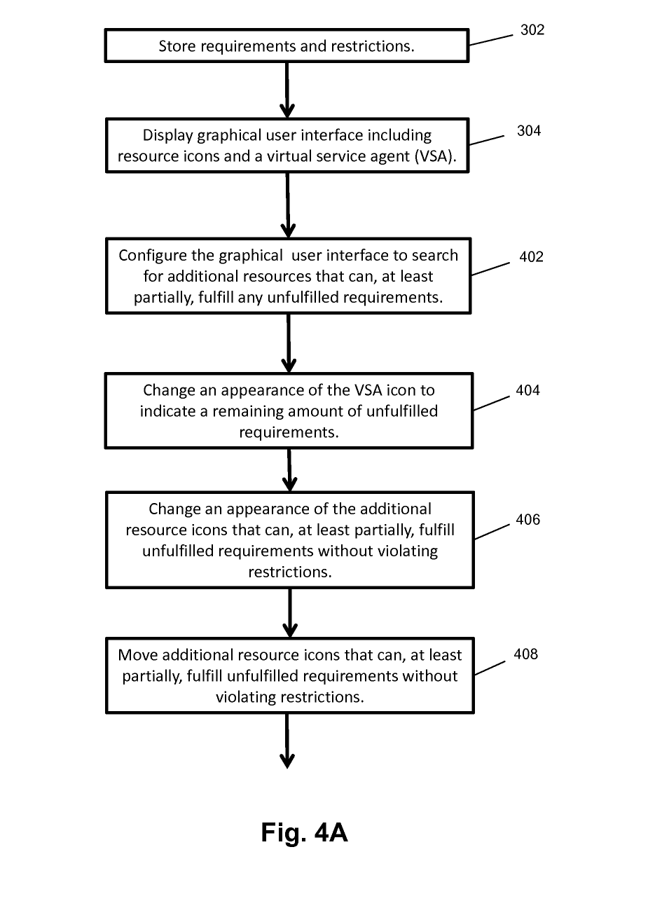

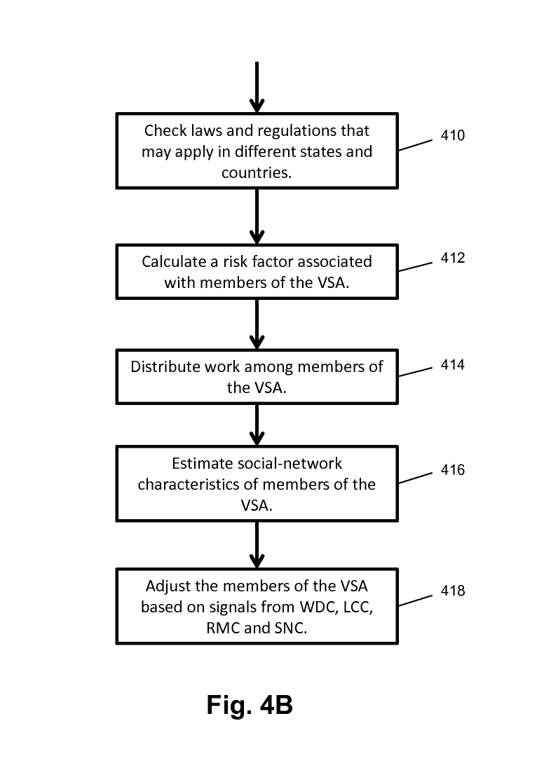

Hubs are entities that direct to a large number of authorities. Hubs may mutually reinforce analogues to authorities. For example, authorities may point to hubs and hubs point to authorities. After the associating step 308 is completed, the method may continue to configuring step 402 in FIG. 4A.

FIGS. 4A and 4B show another method for managing resources for tasks in accordance with one embodiment of the present invention. Steps 302 and 304 are the same steps discussed above for FIG. 3. At configuring step 402, the graphical user interface is configured to, in response to the resource icon being dragged and dropped onto the VSA icon, search for additional resources that can, at least partially, fulfill any unfulfilled requirements associated with the task without violating the restrictions associated with the task. After configuring step 402 is completed, the process continues to changing step 404.

At changing step 404, the appearance of the VSA icon is changed to indicate a remaining amount of unfulfilled requirements associated with the task by the graphical user interface. Once changing step 404 is completed, the process continues to changing step 406.

At changing step 406, the appearance of the additional resource icons that can, at least partially, fulfill any unfulfilled requirements associated with the task without violating the restrictions associated with the task are changed by configuring the graphical user interface. After changing step 406 is completed, the method proceeds to moving step 408.

At moving step 408, additional resource icons 105 and 107 that can, at least partially, fulfill any unfulfilled requirements associated with the task without violating the restrictions associated with the task are moved closer to the VSA icon by configuring the graphical user interface. After moving step is completed, the method continues to checking step 410.

At checking step 410, laws and regulations that may apply to members of the VSA in different states and countries are checked using a legal-checking component (LCC). The legal checking component (LCC) may consider various aspects of rules, regulations, and laws. Various legal challenges may exist with respect to the creation and operation of help desks and the employment of help-desk staffs in a global business environment. As an example, various privacy laws exist and these may depend on different countries in which employees reside. The U.S. government may control exports, with a consideration of such aspects as national security, human rights, international commitments, etc.

Other considerations include ASCA (Administrative Simplification Compliance Act) and The Sarbanes-Oxley Act (SOX), a United States federal law setting standards for all U.S. public company boards, management and public accounting firms. Various concerns exist with respect to data retention and discarding.

In one embodiment, when the confidence associated with aspects of the above does not fulfill the requirements and restrictions, the drag-and-drop may automatically trigger a query to an appropriate individual (e.g., a person in charge of export controls). After checking step 410 is completed, the process continues to calculating step 412.

At calculating step 412, a risk factor associated with the members of the VSA in fulfilling the requirements of the task is calculated using a risk-management component (RMC). Various risk-management challenges may exist with respect to the creation and operation of help desks and the employment of help-desk staffs in a global business environment. As an example, the qualifications of individuals in a help-desk may be known to a certain degree. For instance, the VSA may be knowledgeable about a particular computer operating system with a certain degree of competence. The more competent the VSA is, the lower the risk. Certain regulations, while not necessarily required, may be deemed to be beneficial and thus decrease the risk of certain problems arising. If a DeepQA artificial agent is part of the VSA, risk may be diminished. After calculating step 412 is completed, the process continues to distributing step 414.

At distributing step 414, work among the members of the VSA is distributed using a workload-distribution component (WDC). The WDC may consider the distribution of work among the VSA and its components. As just one example, an overworked team or individual may become less efficient or helpful. The WDC may also consider that it is desirable to have workers who are diverse, adhere to certain business conduct guidelines, and who are from companies that adhere to certain kinds of labor laws or privacy policies. After distributing step 414 is completed, the process continues to estimating step 416.

At estimating step 416, social-network characteristics of the members of the VSA are estimated using a social networking component (SNC). In one embodiment, the social-network component (SNC) may be used to estimate various attributes of people that form the VSA. For example, for certain kinds of work, situations, scenarios, help-desk assignments, and various other jobs, it may be beneficial to compose the VSA from a collection of one or more individuals that has one or more of the following attributes: high social network connectivity (e.g., many Twitter followers, may emails sent per unit time, etc.), an ability or desire to work in solitude or with teams of different sizes, etc.

Additionally, individuals or the VSA may have various attributions that may be used with respect to Degree Centrality, Betweenness Centrality, Closeness, Eigenvalue Hub, and Authority (as defined above). The VSA icon may indicate the degree to which the VSA has such attributes (because one or more of its members has such attributes) using color, size, shape, etc. After estimating step 416 is completed, the process continues to adjusting step 418.

At adjusting step 418, members of the VSA are adjusted based on signals from at least one of the workload-distribution component (WDC), the legal-checking component (LCC), the risk-management component (RMC), and the social-networking component (SNC) using a VSA formation component (VFC).

Accordingly, embodiments of the invention may address the legal/regulatory difficulties when forming teams of people around the world to accomplish a business task. In one embodiment of the invention, there is a system and method for creating and representing service personnel (e.g., in a help-desk scenario) as the VSA representing one or more actual people. Risk may be mitigated by ensuring that these teams have at least one member that is an AI agent capable of answering questions posed in natural language, using DeepQA technology.

In this manner, the focus is not so much on changing appearances of the VSA icon and resource icons but on a preventing of a building of the VSA based on the rules-checking engine. In one embodiment, one member of the VSA can involve DeepQA technology. As an example, a resource icon cannot be dragged to the VSA if a regulatory rule is not met. Similarly, if the team must be composed of three people (and we already have two people), we need to have the one more resource be a DeepQA agent. Thus, if an attempt is made to drag a human resource, this action is prevented.

According to an embodiment of the invention, the graphical user interface includes an integrated representation of a service agent (e.g., sales agent or composite caregiver) composed of several members, the membership of which is controlled by an automated assessment of an SNC and an LCC. The performance of the composite agent may be monitored and optimized.

The primary business need addressed by the VSA may involve the creation of a mechanism that integrates characteristics, attributes, and capabilities normally associated with skilled resources, business processes, information, or technology so as to enhance predictability, repeatability, and reusability of IT services, work flow, process automation, and business logic. The number of VSA configurations may represent an organization's total potential capacity to meet demand for IT or related services.

In one embodiment, the graphical user interface may interact with service members of a service simulacrum (e.g., a single VSA is actually a composite of several actual people). Persistent storage may be configured to store collective qualifications of the simulacrum based on the individual qualifications of the simulacrum members, while a simulacrum broker (including the VSA formation component) may be configured to present the collective qualifications to third parties. Thus, the broker can provide a dynamic representation of the collective cost information, knowledge, skills and experience of a simulacrum or virtual service agent along with information on risk, legal concerns, and workload distribution associated with the VSA. Furthermore, the broker can enable an entity, such as a simulacrum employer or person seeking service from the simulacrum (i.e., VSA), to interact with the simulacrum as if that simulacrum were a single entity, rather than a collection of individual members.

A Work Management construct or matrix (e.g., in the form of a database set of records) may allow the system to define patterns and policies around groups of skilled resources, and these patterns and policies can then be applied in a variety of ways to determine the best (most efficient or cost effective, or least-risk) work management plan and schedule for the VSA composite.

The VSA concept disclosed here may apply to other fields in which, for example, composite helpers are needed and when there exist legal and related concerns. As an example, this invention may apply to virtual sales people composed of several individuals but represented as an integrated customer-facing entity. Here, each member of the VSA may have associated data records specifying such parameters as past sales results, other performance ratings, etc. Additionally, the LCC may be used to check laws and regulations that may apply to members of the VSA in different states and countries. The performance of the sales VSA may be monitored and mined in order to understand and create the characteristics of the VSA that are most successful and to optimize assignments, matches, and opportunities. For example, if three members compose the sales VSA, and this VSA has higher sales than other VSAs, various characteristics of the members can be studied in an automated fashion (e.g., by accessing database records and using analytics).

In healthcare, the VSA may represent a health service agent or composite caregiver composed of many individual members with various expertises. Here, the WDC may be used to ensure that one member of the VSA caregiver does not become over-burdened, and the LCC can be used to enforce rules and regulations. The SNC can be used to help ensure that the caregiver have an appropriate sociability level, or the needed connections to experts who may help in times of need.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for managing resources for tasks, the system comprising:
a rules database storing requirements and restrictions associated with a task; and
a graphical user interface including resource icons of resources that can, at least partially, fulfill the requirements of the task, and a virtual service agent (VSA) icon of a VSA associated with the task such that when resource icon is attempted to be dragged and dropped onto the VSA icon, the graphical user interface permits or prohibits the dragging and dropping responsive to a rules-checking module that checks violations of the restrictions; and
an agent-checking module that ensures that at least one resource includes a software agent configured to answer natural language questions by querying data repositories, and applying language processing, information retrieval and machine learning to arrive at a conclusion.

2. The system of claim 1, wherein the VSA is formed by a VSA formation component (VFC) that adjust properties of the VSA based on signals from a workload-distribution component (WDC), a legal-checking component (LCC), a risk-management component (RMC), and/or a social-networking component (SNC).

3. The system of claim 2, wherein the WDC, LCC and RMC make use of the requirements and restrictions.

4. The system of claim 2, wherein the graphical user interface prohibits dragging and dropping the resource icon onto the VSA if at least one of the WDC, LCC, RMC and SNC indicate that the resource associated with the resource icon does not meet the requirements and restrictions of the task.

5. The system of claim 2, wherein the graphical user interface encourages dragging and dropping the resource icon onto the VSA if at least one of the WDC, LCC, RMC and SNC indicate that the resource associated with the resource icon meets the requirements and restrictions of the task.

6. The system of claim 1, wherein dragging and dropping the resource icon onto the VSA automatically triggers a query for a resource that can, at least partially, fulfill remaining requirements of the task.

7. The system of claim 1, wherein the graphical user interface includes at least one visual widget to adjust at least one of the requirements and the restrictions of the task.

8. The system of claim 1, wherein the VSA icon shows the amount of unfulfilled requirements of the task.

9-17. (canceled)

18. A computer program product for managing resources for tasks, the computer program product comprising:
a computer readable storage medium having computer readable program code embodied therewith, the computer readable program code configured to:
store requirements and restrictions associated with a task in a rules database; and
display a graphical user interface including resource icons of resources that can, at least partially, fulfill the requirements of the task, and a virtual service agent (VSA) icon of a VSA associated with the task such that when a resource icon is attempted to be dragged and dropped onto the VSA icon, the graphical user interface permits and prohibits the dragging and dropping responsive to a rules-checking module that checks violations of the restrictions and a checking module that ensures that at least one resource includes a software agent configured to answer natural language questions by querying data repositories, and applying language processing, information retrieval and machine learning to determine answers to the natural language questions.

19. The computer program product of claim 18, further comprising computer readable program code to:
specify, in the rules database, social-network connectivity characteristics that must be fulfilled by one or more resources of the VSA; and
associate the social network connectivity characteristics with the task.

20. The computer program product of claim 19, wherein the social-network connectivity characteristics include at least one of:
a degree centrality parameter specifying a minimum number of direct relationships of the VSA;
a betweenness centrality parameter specifying the VSA's minimum position within a network in terms of its ability to make connections to other entities in a network;
a closeness parameter specifying how quickly the VSA can access more entities in the network;
an Eigenvalue parameter specifying how close the VSA is to other highly close entities within the network;
an authority parameter specifying the minimum number of network nodes that point to the VSA; and
a hub parameter specifying the minimum number of authorities the VSA must point to.

21. The computer program product of claim 18, further comprising computer readable program code to change an appearance of the VSA icon to indicate a remaining amount of unfulfilled requirements associated with the task by the graphical user interface.

22. The computer program product of claim 18, wherein the graphical user interface is configured to, in response to the resource icon being dragged and dropped onto the VSA icon, search for additional resources that can, at least partially, fulfill any unfulfilled requirements associated with the task without violating the restrictions associated with the task.

23. The computer program product of claim 22, further comprising computer readable program code to change an appearance of the additional resource icons that can, at least partially, fulfill any unfulfilled requirements associated with the task without violating the restrictions associated with the task by configuring the graphical user interface.

24. The computer program product of claim 23, further comprising computer readable program code to move the additional resource icons that can, at least partially, fulfill any unfulfilled requirements associated with the task without violating the restrictions associated with the task closer to the VSA icon by configuring the graphical user interface.

25. The computer program product of claim 18, further comprising computer readable program code to:
check laws and regulations that may apply to members of the VSA in different states and countries using a legal-checking component (LCC);
calculate a risk factor associated with the members of the VSA in fulfilling the requirements of the task using a risk-management component (RMC);
distribute work among the members of the VSA using a workload-distribution component (WDC);
estimate social-network characteristics of the members of the VSA using a social-networking component (SNC); and
adjust the members of the VSA based on signals from at least one of the workload-distribution component (WDC), the legal-checking component (LCC), the risk-management component (RMC) and the social-networking component (SNC) using a VSA formation component (VFC).
